(19) United States
(12) Patent Application Publication
(10) Pub. No.: US 2025/0011127 A1
(43) Pub. Date: Jan. 9, 2025

(54) DISTANCE SENSOR DEVICE FOR MONITORING A LOCK CLEARANCE OF AN ELEVATOR DOOR LOCKING DEVICE

(71) Applicant: KONE Corporation, Helsinki (FI)

(72) Inventor: Olli Aaltonen, Helsinki (FI)

(73) Assignee: KONE Corporation, Helsinki (FI)

(21) Appl. No.: 18/887,713

(22) Filed: Sep. 17, 2024

Related U.S. Application Data
(63) Continuation of application No. PCT/FI2022/050220, filed on Apr. 6, 2022.

(51) Int. Cl. B66B 5/00; B66B 13/06; B66B 13/16

(52) U.S. Cl. CPC B66B 5/0025; B66B 13/16; B66B 13/06

(57) ABSTRACT

A distance sensor device for monitoring a lock clearance of an elevator door locking device of an elevator car door operator is arranged to one of the following: a static structure of the elevator door operator or a hanger plate of the elevator car door operator. The distance sensor device is configured to obtain distance data in a direction parallel to the lock clearance of the elevator door lock device, when the elevator door is locked by the elevator door locking device. The obtained distance data represents the lock clearance of the elevator door lock device. An elevator car door operator includes the distance sensor device and a method monitors a lock clearance of an elevator door locking device of an elevator car door operator.

### TECHNICAL FIELD

The invention concerns in general the technical field of elevator systems. Especially the invention concerns elevator doors and their locking devices.

### BACKGROUND

Typically, elevator door locking devices are having a small clearance between a lock hook and a lock counterpart, when the elevator door is locked by the elevator door locking device. This clearance may be called as a lock clearance of the elevator door locking device. However, too small lock clearance may cause problems in the operation of the elevator door locking device. For example, the elevator door locking device may get jammed due to a reduced lock clearance or even completely lost lock clearance. There may be several reasons, which may cause the lock clearance to be reduced or even lost completely. These reasons may for example comprise installation mistakes, manufacturing tolerances, assembly tolerances, and/or external reasons, such as stones between the elevator door and the door frame. When the lock clearance is reduced or lost, faults leading to call-outs may occur, e.g. lock jamming call-outs. For example, in case of lock jamming call-outs, entrapment situations may be quite common.

Typically, the lock clearance of the elevator door locking device may be inspected during a maintenance visit by a maintenance personnel. If the maintenance personnel notice a reduced lock clearance, the maintenance personnel may adjust it.

Typically, elevator car door operators comprising the elevator door locking device comprise a reference switch for obtaining installation data during an installation phase of the elevator car door operator and close end signal data. The installation data may comprise direction data indicating the closing side of the elevator door. The close end signal data may indicate that the elevator door is closed. The reference switch may provide the installation data and the close end signal data to a door control unit of the elevator car door operator, which uses the obtained installation data and the close end signal data for example during the installation and implementation of the elevator car door operator.

Therefore, there is a need to develop further solutions to observe the lock clearance of the elevator door locking device.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a distance sensor device, an elevator door operator, and a method for monitoring a lock clearance of an elevator door locking device. Another objective of the invention is that the distance sensor device, the elevator door operator, and the method for monitoring a lock clearance of an elevator door locking device enable providing data representing the lock clearance of an elevator door locking device.

The objectives of the invention are reached by a distance sensor device, an elevator door operator, and a method as defined by the respective independent claims.

According to a first aspect, a distance sensor device for monitoring a lock clearance of an elevator door locking device of an elevator car door operator is provided, the distance sensor device is arranged to one of the following: a static structure of the elevator door operator or a hanger plate of the elevator car door operator, wherein the distance sensor device is configured to obtain distance data in a direction parallel to the lock clearance of the elevator door lock device, when the elevator door is locked by the elevator door locking device, wherein the obtained distance data represents the lock clearance of the elevator door locking device.

The lock clearance of the elevator door locking device may be defined by a distance between a lock latch of the elevator door locking device attached to a hanger plate of the elevator door operator and a lock counterpart of the elevator door locking device attached to a static structure of the elevator door operator.

The distance sensor device may further be configured to be calibrated by arranging the hanger plate of the elevator car door operator against a buffer arranged to the static structure of the elevator car door operator to define a change of the locking clearance of the elevator door locking device based on the obtained distance data.

After the calibration the distance data obtained by the distance sensor device may indicate a distance between the hanger plate and the buffer corresponding to the change of the lock clearance of the elevator door locking device.

The calibration of the distance sensor device may comprise zeroing the reading of the distance sensor device or obtaining reference distance data by the distance sensor device, when the hanger plate of the elevator car door operator is arranged against the buffer.

The distance sensor device may further be configured to obtain installation data during an installation phase of the elevator car door operator, wherein the installation data may comprise direction data indicating the closing side of the elevator door.

Alternatively or in addition, the distance sensor device may further be configured to obtain close end signal data indicating that the elevator door is closed.

According to a second aspect, an elevator car door operator is provided, wherein the elevator door operator comprises: an electric motor, a door control unit, at least one hanger plate for carrying at least one elevator door panel, an elevator door locking device, and a distance sensor device as described above for monitoring a lock clearance of the elevator door locking device.

According to a third aspect, a method for monitoring a lock clearance of an elevator door locking device of an elevator car door operator with a distance sensor device arranged to one of the following: a static structure of the elevator door operator or a hanger plate of the elevator car door operator is provided, wherein the method comprises obtaining distance data in a direction parallel to the lock clearance of the elevator door locking device, when the elevator door is locked by the elevator door locking device, wherein the obtained distance data represents the lock clearance of the elevator door locking device.

The lock clearance of the elevator door locking device may be defined by a distance between a lock latch of the elevator door locking device attached to the hanger plate of the elevator door operator and a lock counterpart of the elevator door locking device attached to the static structure of the elevator door operator.

The method may further comprise calibrating the distance sensor device by arranging the hanger plate of the elevator car door operator against a buffer arranged to the static structure of the elevator car door operator to define a change of the locking clearance of the elevator door locking device based on the obtained distance data.

After the calibration, the distance data obtained by the distance sensor device may indicate a distance between the hanger plate and the buffer corresponding to the change of the lock clearance of the elevator door locking device.

The calibrating of the distance sensor device may comprise zeroing the reading of the distance sensor device or obtaining reference distance data by the distance sensor device, when the hanger plate of the elevator car door operator is arranged against the buffer.

The method may further comprise obtaining installation data during an installation phase of the elevator car door operator, wherein the installation data may comprise direction data indicating the closing side of the elevator door.

Alternatively or in addition, the method may further comprise obtaining close end signal data indicating that the elevator door is closed.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator car door operator.

FIG. 2A illustrates schematically another example of the elevator car door operator.

FIG. 2B illustrates a closer view of a circled area of the elevator car door operator of FIG. 2A.

FIG. 2C illustrates an end view of the elevator door locking device of FIG. 2B.

FIG. 2D illustrates an example of a reduced lock clearance of an elevator door locking device.

FIG. 3 illustrates schematically an example of a method for monitoring a lock clearance of an elevator door locking device.

### DESCRIPTION OF THE EXEMPLIFYING EMBODIMENTS

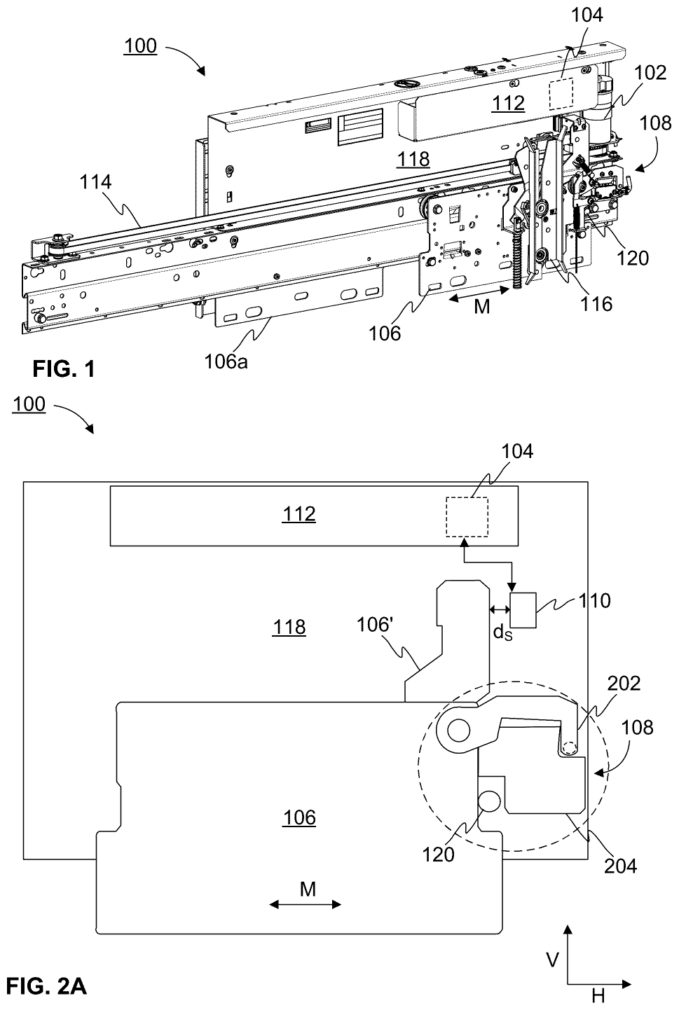

FIG. 1 illustrates schematically an example of an elevator car door operator 100 for opening and closing an elevator car door. The elevator car door operator 100 comprises an electric motor 102, a door control unit 104, at least one hanger plate 106 for carrying at least one elevator door panel of the elevator door, an elevator door locking device 108, and a distance sensor device 110 (not shown in FIG. 1). For sake of clarity the at least one door panel is not show in FIG. 1. The example elevator car door operator 100 of FIG. 1 is for opening and closing a side opening elevator door. The side opening door may comprise at least one elevator door panel. The elevator car door operator 100 may comprise at least one hanger plate 106, 106a, i.e. one hanger plate 106, 106a for each elevator door panel. In the example of FIG. 1, the side opening door comprises two elevator door panels. Therefore, the example elevator car door operator 100 of FIG. 1 comprises two hanger plates 106, 106a, e.g. a main hanger plate 106, and a secondary 106a. The elevator car door operator 100 may also be for opening and closing a center opening elevator door comprising at least two elevator door panels, wherein the elevator car door operator 100 comprises at least two hanger plates 106, i.e. one hanger plate 106 for carrying each elevator door panel. The elevator door locking device 108 may typically be arranged in association with one hanger plate 106, 106a of the elevator car door operator 100. In the example of FIG. 1 the elevator door locking device 108 is arranged in association with the (main) hanger plate 106. The door control unit 104 may for example be accommodated in a housing 112. The door control unit 104 may be configured to control the operation of the entities of the elevator car door operator 100. The elevator car door operator 100 may further comprise one or more other known entities, e.g. a belt 114 with belt driving pulleys, a door coupler 116, power supply connections, a transformer, a synchronization rope, etc. The power supply connections and the transformer may for example be accommodated in the same housing 112 as the door control unit 104 or in a separate housing. The door control unit 104 is configured to control a motion of the electric motor 102. The electric motor 102 moves the at least one hanger plate 106 and thus also the at least one door panel of the elevator door with the belt 114 that converts a rotational motion generated by the electric motor 102 into a linear motion. The movement of the at least one hanger plate 106 and the at least one door panel is linear along the horizontal direction H. Thus, also the movement of the elevator door is linear along the horizontal direction H. In other words, the movement direction of the elevator door is along the horizontal direction H. The movement direction of the elevator door is illustrated in FIG. 1 with the reference letter M. The at least one hanger plate 106 is moving in relation to a static structure 118 of the elevator car door operator 100, e.g. a railing profile. The static structure 118 of the elevator car door operator 100 may be attached to the elevator car. The elevator door locking device 108 may be a locking device of an elevator car door. The elevator door may also comprise also a landing door. The landing door may be opened by opening movement of the elevator car door and closed by the closing movement of the elevator car door by using the door coupler 116 attached to the hanger plate 106. A buffer 120 is arranged to the static structure 118 of the elevator car door operator 100. The shapes and sizes of the entities of the elevator car door operator 100 illustrated in Figures of this application are only exemplary and non-limiting. Thus, the entities of the elevator car door operator 100 may also have any other shape and/or size.

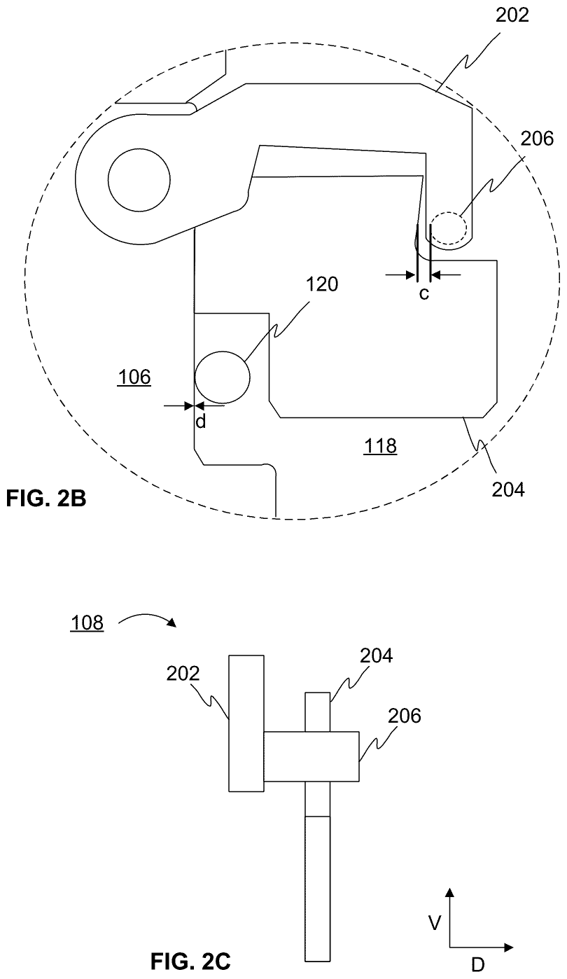

FIG. 2A illustrates another example of the elevator car door operator 100. The example elevator car door operator 100 of FIG. 2A is otherwise similar to the example elevator car door operator 100 of FIG. 1 (i.e. may comprise the entities as the elevator car door operator 100 of FIG. 1), but it is illustrated in a simplified way and the elevator door locking device 108 and the distance sensor device 110 are shown better in FIG. 2A. The elevator door locking device 108 comprises a lock latch 202, e.g. a lock hook, and a lock counterpart 204. The lock latch 202 is attached, i.e. fixed, to the hanger plate 106. The lock counterpart 204 is attached to the static structure 118 of the elevator car door operator 100. The lock hook 202 of the elevator door locking device 108 is attached to the hanger plate 106 meaning that the elevator door locking device 108 is arranged in association with the hanger plate 106 as discussed above. FIG. 2B illustrates a closer view of the circled (with a dashed line) area of the elevator car door operator 100 of FIG. 2A. In FIGS. 2A and 2B the elevator door locking device 108 is in a locked position. When the elevator door locking device 108 is in the locked position the elevator door is locked by the elevator door locking device 108. In the locked position of the elevator door locking device 108, the locking device 108 prevents the opening of the elevator door. The lock latch 202 is arranged in relation to the lock counterpart 204 so that the lock latch 202 and the lock counterpart 204 are able to establish the locking in the locking position of the elevator door locking device 108. FIGS. 2A and 2B illustrates only one example location for the elevator door locking device 108 and the elevator door locking device 108 may also be arranged to any other location in association with the hanger plate 106, i.e. so that the lock latch 202 is attached to the hanger plate 106 to any other location in the hanger plate 106 so that the lock latch 202 is able to establish the locking with the lock counterpart 204 attached to a respective location in the static structure 118.

When the elevator door is locked by the elevator door locking device 108, i.e. the elevator door locking device 108 is in the locked position, there exists a clearance, i.e. a distance, between the lock latch 202 and the lock counterpart 204. In other words, the lock clearance of the elevator door locking device 108 may be defined by the distance between the lock latch attached to the hanger plate 106 and the lock counterpart 204 attached to the static structure 118. More specifically, the lock clearance may be defined to exist between a locking part 206 of the lock latch 202 and the lock counterpart 204. The locking part 206 of the lock latch 202 is the part of the lock latch 202 that establishes the locking with the lock counterpart 204. In the example of FIGS. 2A and 2B, the lock clearance is defined between the locking part 206 of the lock latch 202 the lock counterpart 204. In the example of FIG. 2A and 2B, the locking part 206 of the lock latch 202 is substantially cylindrical, but the locking part 206 of the lock latch 202 may also have any other shape as long as it is capable to establish the locking with the lock counterpart 204. Similarly, the lock counterpart 204 may have any other shape as long as it is capable to establish the locking with the lock latch 202, e.g. with the locking part 206 of the lock latch 202. FIG. 2C illustrates an end view of the elevator door locking device 108 in the locked position of FIG. 2B. FIG. 2C shows that the locking part 206 of the lock latch 202 extends in a depth direction D behind the lock counterpart 204 to establish the locking of the elevator door locking device 108. The locking part 206 of the lock latch 202 may be implemented as a separate part that is fixed to the lock latch 202 as illustrated in the example of FIG. 2C. Alternatively, the locking part 206 of the lock latch 202 may be formed from the material of the lock latch 202. The lock clearance represents the distance between the lock latch 202, e.g. the locking part 206 of the lock latch 202, and the lock counterpart 204 in the horizontal direction H, i.e. in the movement direction of the hanger plate 106 and thus also in the movement direction of the elevator door M.

In the example of FIGS. 2A and 2B the buffer 120 is arranged to the static structure 118 in the horizontal direction H so that the hanger plate 106 reaches, e.g. is in a contact with, the buffer 120, when the elevator door locking device 108 is in the locked position. In other words, in the example of FIGS. 2A and 2B a distance d between the hanger plate 106 and the buffer 120 is substantially zero, when the elevator door locking device 108 is in the locked position with the predefined lock clearance of the elevator door locking device 108. The distance d between the hanger plate 106 and the buffer 120 is a horizontal distance between the hanger plate 106 and the buffer 120. In other words, the distance d represents the distance between the hanger plate 106 and the buffer 120 in the horizontal direction, i.e. in the movement direction of the hanger plate 106 and thus also in the movement direction of the elevator door M. More specifically, in the example of FIGS. 2A and 2B, the lock hatch 202 side of the hanger plate 106 (i.e. the side of the hanger plated 106 to which the lock hatch 202 is attached) reaches the buffer 120, when the elevator door locking device 108 is in the locked position. In the vertical direction V the buffer 120 may be arranged to the static structure 118 at any location as long as the hanger plate 106 is able to reach the buffer 120. FIGS. 2A and 2B illustrates only one possible location of the buffer 120 in the vertical direction. FIG. 2B illustrates also that there exists the lock clearance of the elevator locking device 108, when the elevator door locking device 108 is in the locked position. The locking clearance may be a predefined lock clearance of the elevator door locking device 108, when the elevator door locking device 108 is in the locked position and the hanger plate 106 reaches the buffer 120. The predefined locking clearance may for example be defined so that the elevator door locking device 108 does not get jammed due to a too small lock clearance and so that the elevator door locking device 108 still remains in the locking position. According to a non-limiting example, the predefined locking clearance may for example be between 2 to 3 millimeters. However, the invention is not limited to that, and the predefined locking clearance may be less than or more than the above mentioned non-limiting example. For example, the lock clearance may be adjusted according to the predefined lock clearance during an installation of the elevator door locking device 108 and/or during a maintenance of the elevator door locking device 108. In FIG. 2B the lock clearance is illustrated with the reference letter c and the distance between the hanger plate 106 and the buffer 120 (which is in this example substantially zero) is illustrated with the reference letter d. The distance d between the hanger plate 106 and the buffer 120 is parallel to the lock clearance c of the elevator door locking device 108. The example of FIG. 2B may for example illustrate an example of a calibration situation of the distance sensor device 110, wherein the hanger plate is arranged, e.g.

pushed against the buffer 120. The calibration of the distance sensor device 110 is discussed more later in this application.

FIG. 2D illustrates an example situation of a reduced lock clearance of the elevator door locking device 108. FIG. 2D is otherwise similar to FIG. 2B, but the hanger plate 106 does not reach, e.g. is not in a contact with, the buffer 120. This means that there is a non-zero distance d between the hanger plate 106 and the buffer 120, which in turn leads also to a change, i.e. reduce, of the lock clearance of the elevator door locking device 108. In FIG. 2D the reduced lock clearance is illustrated with the reference letter c′. The change of the lock clearance Δc may for example be defined as an absolute value of a difference, i.e. a subtraction, between the reduced lock clearance and the predefined lock clearance, i.e. Δc=|c′−c|. Because the lock latch 202 is attached to the hanger plate 106 and the lock counterpart 204 is attached to the static structure 118, the lock latch 202 is moving together with the hanger plate 106, while the lock counterpart 204 and the buffer 120 attached to the static structure 118 remain stationary. Therefore, a displacement, i.e. a movement distance, of the hanger plate 106 in the horizontal direction H in relation to the buffer 120 is equal to a displacement, i.e. a movement distance, of the lock latch 202 in the horizontal direction H in relation to the lock counterpart 204. Thus, the distance d between the hanger plate 106 and the buffer 120 corresponds to the change, i.e. reduce, of the lock clearance of the elevator door locking device 108, i.e. d=Δd. In other words, when the distance d between the hanger plate 106 and the buffer 120 increases, the lock clearance c of the elevator door locking device 108 reduces correspondingly.

The distance sensor device 110 may be arranged, e.g. attached, to the static structure 118 of the elevator door operator 100 as illustrated in FIGS. 1 and 2A. Preferably, the distance sensor device 110 is arranged to the static structure 118 of the elevator door operator 100. It enables more convenient coupling, e.g. wiring, of the distance sensor device 110 to the door control unit 104. The wiring enables wired communication between the distance sensor device 110 and the door control unit 104. Alternatively or in addition, the communication between the distance sensor device 110 and the door control unit 104 may be based on one or more wireless communication technologies. When the distance sensor device 110 is arranged to the static structure 118 it is configured to measure a distance ds to hanger plate 106 (i.e. the distance from the distance sensor device 110 to the hanger plate 106), when the elevator door locking device 108 is in the locked position. The distance dₛ represents the distance to hanger plate 106 (i.e. the distance from the distance sensor device 110 to the hanger plate 106) in the horizontal direction H, i.e. in the movement direction of the hanger plate 106 and thus also in the movement direction of the elevator door M. The distance ds to hanger plate 106 (i.e. the distance from the distance sensor device 110 to the hanger plate 106) is parallel to the lock clearance of the elevator door locking device 108. Alternatively, the distance sensor device 110 may be arranged to the hanger plate 106 of the elevator car door operator 100. When the distance sensor device 110 is arranged to the hanger plate 106, the distance sensor device 110 is configured to measure a distance to a sensor counterpart arranged to the static structure 118 (i.e. the distance from the distance sensor device 110 to the sensor counterpart) in the horizontal direction H, when the elevator door locking device 108 is in the locked position. The distance to the sensor counterpart (i.e. the distance from the distance sensor device 110 to the sensor counterpart) is parallel to the lock clearance c of the elevator door locking device 108. The sensor counterpart may for example be the buffer 120 or some other already existing entity arranged to the static structure 118, or any other part arranged to the static structure 118. From now on in this patent application the different aspects of the invention are discussed by using the implementation, wherein the distance sensor device 110 is arranged to the static structure 118 e.g. as illustrated in FIG. 2A. However, all the aspects of the invention may also be applied by using the using the implementation, wherein the distance sensor device 110 is arranged to the hanger plate 106, by using the measured distance from the distance sensor device 110 to sensor counterpart instead of the measured distance ds from the distance sensor device 110 to the hanger plate 106. In the example of FIG. 2A, the distance sensor device 100 is arranged to the static structure 118 substantially close to the door control unit 104, which also enables the more convenient coupling of the distance sensor device 110 to the door control unit 104. The hanger plate 106 may for example comprise an extension part 106′, as illustrated the example of FIG. 2A, to enable that the distance sensor device 110 may be arranged to the static structure 118 substantially close to the door control unit 104. The extension part 106′ of the hanger plate 106 belongs to the hanger plate 106 and thus is configured to move with the hanger plate 106, when the hanger plate 106 is moving. However, the distance sensor device 110 may be arranged to the static structure 118 at any other location as long as the distance sensor device 110 is capable to measure the distance dₛ to hanger plate 106 in the horizontal direction H, when the elevator door locking device 108 is in the locked position. In other words, the distance sensor device 110 may be arranged to the static structure 118 in relation to the hanger plate 106 so that the distance sensor device 110 is capable to measure the distance dₛ to hanger plate 106 in the horizontal direction H, when the elevator door locking device 108 is in the locked position. For example, the distance sensor device 110 may also be arranged to the static structure 118 next to the buffer 120 in the vertical direction V (e.g. below the buffer 120 or above the buffer in the vertical direction). According to another example, the distance sensor device 110 may for example be arranged to the buffer 120 itself, e.g. to a side of the buffer 120 facing towards the hanger plate 106. The distance sensor device 110 may be any sensor device capable of measuring distance. For example, the distance sensor device 110 may be a laser-based distance sensor or an inductive distance sensor.

The distance sensor device 110 may be used to monitor the lock clearance of the elevator door locking device 108. To monitor the lock clearance, the distance sensor device 110 is configured to obtain distance data in a direction parallel to the lock clearance of the elevator door locking device 108, when the elevator door locking device 108 is in the locked position, i.e. when the elevator door is locked by the elevator door locking device 108. The obtained distance data represents the lock clearance of the elevator door locking device 108. The obtained distance data may for example represent the change, e.g. the reduce, of the lock clearance Δc of the elevator door locking device 108. The distance sensor device 110 may be configured to provide the obtained distance data to the door control unit 104 of the elevator car door operator 100. The door control unit 104 may forward the obtained distance data for example to an elevator control system, a remote service center, a cloud server, etc.

As discussed above, the distance sensor device 110 is configured to measure the distance dₛ to the hanger plate 106, i.e. the distance from the distance sensor device 110 to the hanger plate 106. As discussed above, the distance dₛ to the hanger plate 106 is parallel to the lock clearance of the elevator door locking device 108. To be able to define the (possible) change of the locking clearance of the elevator door locking device 108 from the obtained distance data, the distance sensor device 110 may be calibrated. The distance sensor device 110 may be calibrated by arranging, e.g. pushing, the hanger plate 106 against the buffer 120, for example as illustrated in the example of FIG. 2B. When the hanger plate 106 is pushed against the buffer 120, i.e. the hanger plate 106 reaches the buffer 120, it is known that the distance d between the hanger plate 106 and the buffer is substantially zero. Thus, by calibrating the distance sensor device 110 by pushing the hanger plate 106 against the buffer 120, the obtained distance data indicates the distance d between the hanger plate 106 and the buffer 120. In other words, the calibration enables that the distance d between the hanger plate 106 and the buffer 120 may be defined based on the obtained distance data. Therefore, the calibration also enables that the change of the locking clearance of the elevator door locking device 108 may also be defined based on the obtained distance data, because the distance d between the hanger plate 106 and the buffer 120 corresponds to the change of the lock clearance of the elevator door locking device 108 as discussed above. The calibration may for example comprise zeroing the reading of the distance sensor device 110, when the hanger plate 106 is pushed against the buffer 120. In that case, the obtained distance data may for example comprise the distance d between the hanger plate 106 and the buffer 120. Alternatively, the calibration may for example comprise obtaining reference distance data, e.g. offset distance data, by the distance sensor device 110, when the hanger plate 106 is pushed against the buffer 120. The distance sensor device 110 may provide the reference distance data to the door control unit 104 and the door control unit 104 may perform the calibration with the reference distance data, when obtaining the distance data from the distance sensor device 110. In that case, the obtained distance data may for example comprise the distance ds to the hanger plate 106 and the distance d between the hanger plate 106 and the buffer 120 and thus also the change of the locking clearance of the elevator door locking device 108 may be defined based on the obtained distance data and the reference distance data.

Next examples of using the distance sensor device 110 for monitoring of the lock clearance of the elevator door locking device 108 (after the calibration) by obtaining the distance data with the distance sensor device 110 are discussed. If the hanger plate 106 reaches the buffer 120, when the elevator door locking device 108 is in the locked position, the distance data obtained by the distance sensor device 110 indicates that there is no distance between the hanger plate 106 and the buffer 120, i.e. the distance d between the hanger plate 106 and the buffer 120 comprised in the obtained distance data is substantially zero. If the obtained distance data indicates that the distance d between the hanger plate 106 and the buffer 120 is substantially zero, when the elevator door locking device 108 is in the locked position, i.e. that the hanger plate 106 reaches the buffer 120, when the elevator door locking device 108 is in the locked position, it also indicates that the lock clearance of the elevator door locking device 108 is not reduced. Alternatively, if the hanger plate 106 does not reach, i.e. is not in contact with, the buffer 120, when the elevator door locking device 108 is in the locked position, the distance data obtained by the distance sensor device 110 indicates that there is distanced d between the hanger plate 106 and the buffer 120. This may for example be caused by installation mistakes, manufacturing tolerances, assembly tolerances, and/or external reasons, e.g. stone(s) between the elevator door panel and a door frame. If the obtained distance data indicates that there is distance d between the hanger plate 106 and the buffer 120, when the elevator door locking device 108 is in the locked position, i.e. that the hanger plate 106 does not reach the buffer 120, when the elevator door locking device 108 is in the locked position, it also indicates that the lock clearance of the elevator door locking device 108 is reduced. In other words, the (possible) change of the lock clearance of the elevator door locking device 108, i.e. the (possible) reduce of the lock clearance of the elevator door locking device 108, may be defined based on the obtained distance data, i.e. based on the distance d between the hanger plate 106 and the buffer 120 comprised in the obtained distance data. This is because the distance d between the hanger plate 106 and the buffer 120 corresponds to the change, i.e. reduce, of the lock clearance of the elevator door locking device 108 as discussed above. As also discussed above, this is because the lock latch 202 of the elevator door locking device 108 is attached to the hanger plate 106 and the lock counterpart 204 of the elevator door locking device 108 is attached to the static structure 118. Consequently, the distance sensor device 110 is configured to measure the distance d between the hanger plate 106 and the buffer 120 and the reduce of the lock clearance of the elevator door locking device 108 indirectly by measuring the distance dₛ to the hanger plate 106. According to a non-limiting example, if the distance data obtained by the distance sensor device 110 indicates that there is 1 millimeter distance between the hanger plate 106 and the buffer 120, when the elevator door locking device 108 is in the locked position, it indicates also that the lock clearance of the elevator door locking device 108 is reduced by 1 millimeter. Monitoring the lock clearance of the elevator door locking device 108 with the distance sensor device 110 enables at least to reduce or event prevent call-outs, e.g. lock jamming call-outs, and/or entrapment situations already before the call-outs and/or entrapment situations occur.

The distance sensor device 110 may further be configured to obtain installation data during an installation phase of the elevator car door operator 100. The installation data may comprise direction data indicating the closing side of the elevator door, i.e. the closing direction of the elevator door. As discussed above, the distance sensor device 110 is configured to measure the distance dₛ to the hanger plate 106. The direction data may for example comprise the measured distance dₛ to the hanger plate 106. The closing side of the elevator door may be defined based on the measured distance to the hanger 106. For example, when the elevator door is closed the measured distance is substantially at its minimum and when the elevator door is open the measured distance is substantially at its maximum. Thus, the closing side of the elevator door may be defined based on the measured distance to the hanger 106 comprised in the direction data of the installation data. The distance sensor device 110 may provide the obtained installation data to the door control unit 104. This enables that the door control unit 104 knows which side is the closing side of the elevator door, and also which direction is the closing direction of the elevator door, i.e. to which direction the elevator door is moving when it closes. The installation phase of the elevator car door operator 100 may for example comprise a learning phase during which the distance sensor device 110 may obtain the installation data.

Alternatively or in addition, the distance sensor device 110 may further be configured to obtain close end signal data. The close end signal data may indicate that the elevator door is closed. As discussed above, the distance sensor device 110 is configured to measure the distance ds to the hanger plate 106. The close end signal data may for example comprise the measured distance ds to the hanger plate 106. For example, when the elevator door is closed the measured distance is substantially at its minimum. Thus, the elevator door being closed may be defined based on the measured distance to the hanger 106 comprised in the close end signal data. The distance sensor device 110 may provide the obtained close end signal data to the door control unit 104. Based on the close end signal data the door control unit 104 knows when it may generate a close end signal to the elevator control system. The distance sensor device 110 may obtain the close end signal data during any operation phase of the elevator car door operator 100 including also the installation phase, e.g. the learning phase.

As the distance sensor device 110 may obtain the installation data and the close end signal data, the distance sensor device 110 may replace a reference switch of the elevator car door operator 100 that is typically used for obtaining the installation data and the close end signal data. Therefore, the distance sensor device 110 may also be configured to operate as the reference switch of the elevator car door operator 100. However, the distance sensor device 110 may also obtain the lock clearance of the elevator door locking device 108 as discussed above. In other words, the distance sensor device 110 may obtain the lock clearance of the elevator door locking device 108 and also the installation data and/or the close end signal data. This enables the distance sensor device 110 may be used for two different purposes, i.e. to obtain the installation data and/or the close end signal data (i.e. act as the reference switch) and to obtain the lock clearance data of the elevator door locking device 108. The distance sensor device 110 may be used simultaneously or nonsimultaneously to obtain the installation data and/or the close end signal data and to obtain the lock clearance data of the elevator door locking device 108.

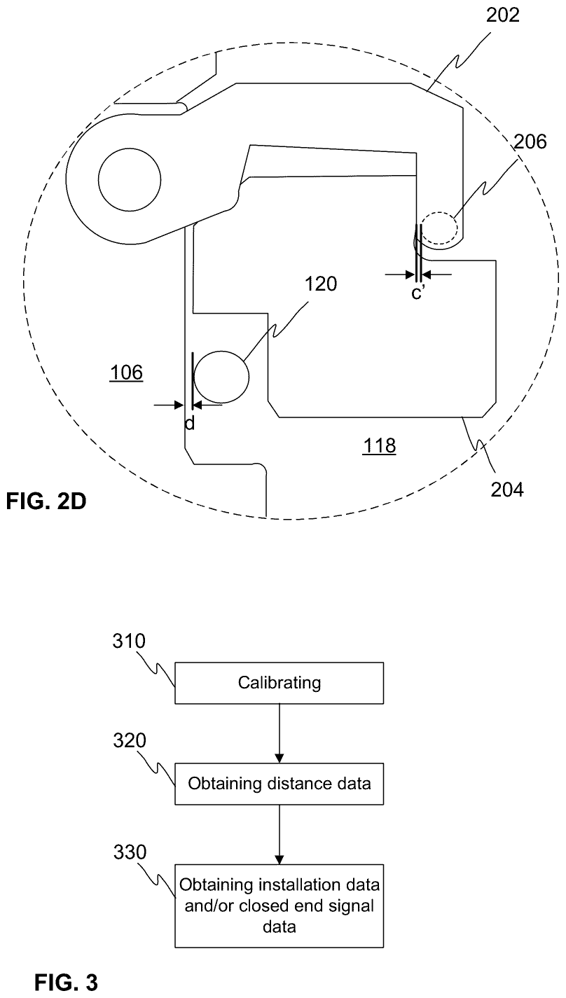

FIG. 3 illustrates schematically an example of a method for monitoring the lock clearance of the elevator door locking device 108 with the distance sensor device 110 described above. FIG. 3 illustrates the method as a flow chart.

At a step 320, the distance sensor device 110 obtains the distance data in the direction parallel to the lock clearance of the elevator door locking device 108, when the elevator door locking device 108 is in the locked position, i.e. when the elevator door is locked by the elevator door locking device 108 as discussed above. The obtained distance data represents the lock clearance of the elevator door locking device 108. The obtained distance data may for example represent the change, e.g. the reduce, of the lock clearance Δc of the elevator door locking device 108. The distance sensor device 110 may provide the obtained distance data to the door control unit 104 of the elevator car door operator 100. As discussed above, the distance sensor device 110 measures the distance dₛ to the hanger plate 106, i.e. the distance from the distance sensor device 110 to the hanger plate 106. As discussed above, the distance dₛ to the hanger plate 106 is parallel to the lock clearance of the elevator door locking device 108. To be able to define the (possible) change of the locking clearance of the elevator door locking device 108 from the obtained distance data the distance sensor device 110 may be calibrated at a step 310 performed before the obtaining the distance data at the step 320.

At the step 310, the distance sensor device 110 may be calibrated by arranging, e.g. pushing, the hanger plate 106 against the buffer 120 as discussed above. When the hanger plate 106 is pushed against the buffer 120, i.e. the hanger plate 106 reaches the buffer 120, it is known that the distance d between the hanger plate 106 and the buffer is substantially zero. Thus, by calibrating the distance sensor device 110 by pushing the hanger plate 106 against the buffer 120, the obtained distance data indicates the distance d between the hanger plate 106 and the buffer 120. In other words, the calibration enables that the distance d between the hanger plate 106 and the buffer 120 may be defined based on the obtained distance data. Therefore, the calibration enables that the change of the locking clearance of the elevator door locking device 108 may also be defined based on the obtained distance data, because the distance d between the hanger plate 106 and the buffer 120 corresponds to the change of the lock clearance of the elevator door locking device 108 as discussed above. The calibration may for example comprise zeroing the reading of the distance sensor device 110, when the hanger plate 106 is pushed against the buffer 120. In that case, the obtained distance data may for example comprise the distance d between the hanger plate 106 and the buffer 120. Alternatively, the calibration may for example comprise obtaining reference distance data, e.g. offset distance data, by the distance sensor device 110, when the hanger plate 106 is pushed against the buffer 120. The distance sensor device 110 may provide the reference distance data to the door control unit 104 and the door control unit 104 may perform the calibration with the reference distance data, when obtaining the distance data from the distance sensor device 110. In that case, the obtained distance data may for example comprise the distance dₛ to the hanger plate 106 and the distance d between the hanger plate 106 and the buffer 120 and thus also the change of the locking clearance of the elevator door locking device 108 may be defined based on the obtained distance data and the reference distance data.

At a step 330, the distance sensor device 110 may further obtain the installation data during the installation phase of the elevator car door operator 100 and/or the close end signal data as discussed above. The distance sensor device 110 may further provide the obtained installation data and/or close end signal data to the door control unit 104 as discussed above.

Although, in FIG. 3 the steps 310 and 320 are presented before the step 330, the distance sensor device 110 may obtain the installation data and/or the close end signal data (step 320) before obtaining the distance data (step 320) or simultaneously with the obtaining the distance data (step 320). In other words, the order of the obtaining the different data by the distance sensor device 110 is not limited and the distance sensor device 110 may obtain the distance data, the installation data, and/or the close end signal data in any order and/or simultaneously.

The specific examples provided in the description given above should not be construed as limiting the applicability and/or the interpretation of the appended claims. Lists and groups of examples provided in the description given above are not exhaustive unless otherwise explicitly stated.

1. A distance sensor device for monitoring a lock clearance of an elevator door locking device of an elevator car door operator, the distance sensor device is being arranged to one of the following:
a static structure of the elevator door operator or a hanger plate of the elevator car door operator,
wherein the distance sensor device is configured to obtain distance data in a direction parallel to the lock clearance of the elevator door lock device, when the elevator door is locked by the elevator door locking device, and,
wherein the obtained distance data represents the lock clearance of the elevator door locking device.

2. The distance sensor device according to claim 1, wherein the lock clearance of the elevator door locking device is defined by a distance between a lock latch of the elevator door locking device attached to the hanger plate of the elevator door operator and a lock counterpart of the elevator door locking device attached to the static structure of the elevator door operator.

3. The distance sensor device according to claim 1, further configured to be calibrated by arranging the hanger plate of the elevator car door operator against a buffer arranged to the static structure of the elevator car door operator to define a change of the locking clearance of the elevator door locking device based on the obtained distance data.

4. The distance sensor device according to claim 3, wherein after the calibration, the distance data obtained by the distance sensor device indicates a distance between the hanger plate and the buffer corresponding to the change of the lock clearance of the elevator door locking device.

5. The distance sensor device according to claim 3, wherein the calibration of the distance sensor device comprises zeroing the reading of the distance sensor device or obtaining reference distance data by the distance sensor device, when the hanger plate of the elevator car door operator is arranged against the buffer.

6. The distance sensor device according to claim 1, further configured to obtain installation data during an installation phase of the elevator car door operator, wherein the installation data comprises direction data indicating the closing side of the elevator door.

7. The distance sensor device according to claim 1, further configured to obtain close end signal data indicating that the elevator door is closed.

8. An elevator car door operator comprising:
an electric motor;
a door control unit;
at least one hanger plate for carrying at least one elevator door panel;
an elevator door locking device; and
the distance sensor device according to claim 1.

9. A method for monitoring a lock clearance of an elevator door locking device of an elevator car door operator with a distance sensor device arranged to one of the following:
a static structure of the elevator car door operator or a hanger plate of the elevator car door operator,
wherein the method comprises obtaining distance data in a direction parallel to the lock clearance of the elevator door locking device, when the elevator door is locked by the elevator door locking device,
wherein the obtained distance data represents the lock clearance of the elevator door locking device.

10. The method according to claim 9, wherein the lock clearance of the elevator door locking device is defined by a distance between a lock latch of the elevator door locking device attached to a hanger plate of the elevator door operator and a lock counterpart of the elevator door locking device attached to the static structure of the elevator door operator.

11. The method according to claim 9, further comprising calibrating the distance sensor device by arranging the hanger plate of the elevator car door operator against a buffer arranged to the static structure of the elevator car door operator to define a change of the locking clearance of the elevator door locking device based on the obtained distance data.

12. The method according to claim 11, wherein after the calibration, the distance data obtained by the distance sensor device indicates a distance between the hanger plate and the buffer corresponding to the change of the lock clearance of the elevator door locking device.

13. The method according to claim 11, wherein the calibrating of the distance sensor device comprises zeroing the reading of the distance sensor device or obtaining reference distance data by the distance sensor device, when the hanger plate of the elevator car door operator is arranged against the buffer.

14. The method according to claim 9, further comprising obtaining installation data during an installation phase of the elevator car door operator, wherein the installation data comprises direction data indicating the closing side of the elevator door.

15. The method according to claim 9, further comprising obtaining close end signal data indicating that the elevator door is closed.

16. The distance sensor device according to claim 2 further configured to be calibrated by arranging the hanger plate of the elevator car door operator against a buffer arranged to the static structure of the elevator car door operator to define a change of the locking clearance of the elevator door locking device based on the obtained distance data.

17. The distance sensor device according to claim 4, wherein the calibration of the distance sensor device comprises zeroing the reading of the distance sensor device or obtaining reference distance data by the distance sensor device, when the hanger plate of the elevator car door operator is arranged against the buffer.

18. The distance sensor device according to claim 2 further configured to obtain installation data during an installation phase of the elevator car door operator, wherein the installation data comprises direction data indicating the closing side of the elevator door.

19. The distance sensor device according to claim 3 further configured to obtain installation data during an installation phase of the elevator car door operator, wherein the installation data comprises direction data indicating the closing side of the elevator door.

20. The distance sensor device according to claim 4 further configured to obtain installation data during an installation phase of the elevator car door operator, wherein the installation data comprises direction data indicating the closing side of the elevator door.
